(19) United States
(12) Patent Application Publication
(10) Pub. No.: US 2025/0342815 A1
(43) Pub. Date: Nov. 6, 2025

(54) SYSTEMS AND METHODS FOR AN ARTIFICIAL INTELLIGENCE AVATAR DRIVING COMPANION

(71) Applicant: Toyota Motor North America, Inc., Plano, TX (US)

(72) Inventors: Imad ZAHID, McKinney, TX (US); Raghavassimhan KOMBOOR, Frisco, TX (US); Sumit JHA, Frisco, TX (US)

(73) Assignees: Toyota Motor North America, Inc., Plano, TX (US); Toyota Jidosha Kabushiki Kaisha, Aichi-ken (JP)

(21) Appl. No.: 18/653,485

(22) Filed: May 2, 2024

(51) Int. Cl. G10L 13/033; G10L 13/04

(52) U.S. Cl. CPC G10L 13/033; G10L 13/04

(57) ABSTRACT

A method, computer program product, and computer system for identifying, by a computing device, a scenario of a plurality of scenarios associated with an occupant of a vehicle. A voice profile of an avatar may be determined for the scenario of the plurality of scenarios associated with the occupant of the vehicle. The voice profile of the avatar determined for the scenario of the plurality of scenarios associated with the occupant of the vehicle may be selected, wherein the voice profile of the avatar may be selected from a plurality of voice profiles. Audio may be provided to the occupant of the vehicle using the voice profile of the avatar based upon, at least in part, identifying the scenario of the plurality of scenarios associated with the occupant of the vehicle.

### BACKGROUND

Generally, vehicles may use voice audio to communicate with the occupant of a vehicle. The selection of the voices utilized by the vehicle is, generally, fairly limited. For example, some vehicles allow you to select language, male/female, and accents.

### SUMMARY

In one example implementation, a method, performed by one or more computing devices, may include but is not limited to identifying, by a computing device, a scenario of a plurality of scenarios associated with an occupant of a vehicle. A voice profile of an avatar may be determined for the scenario of the plurality of scenarios associated with the occupant of the vehicle. The voice profile of the avatar determined for the scenario of the plurality of scenarios associated with the occupant of the vehicle may be selected, wherein the voice profile of the avatar may be selected from a plurality of voice profiles. Audio may be provided to the occupant of the vehicle using the voice profile of the avatar based upon, at least in part, identifying the scenario of the plurality of scenarios associated with the occupant of the vehicle.

One or more of the following example features may be included. The voice profile may be selected from a voice library. The voice profile may be generated using a voice model. The voice model may be based upon, at least in part, a sampling of audio. The voice model may be based upon, at least in part, a manual selection of a plurality of voice characteristics. Determining the voice profile of the avatar for the scenario of the plurality of scenarios may include determining a responsiveness level of the occupant of the vehicle to the voice profile of the avatar. The responsiveness level of the occupant of the vehicle may be matched to a level of the scenario of the plurality of scenarios.

In another example implementation, a computing system may include one or more processors and one or more memories configured to perform operations that may include but are not limited to identifying a scenario of a plurality of scenarios associated with an occupant of a vehicle. A voice profile of an avatar may be determined for the scenario of the plurality of scenarios associated with the occupant of the vehicle. The voice profile of the avatar determined for the scenario of the plurality of scenarios associated with the occupant of the vehicle may be selected, wherein the voice profile of the avatar may be selected from a plurality of voice profiles. Audio may be provided to the occupant of the vehicle using the voice profile of the avatar based upon, at least in part, identifying the scenario of the plurality of scenarios associated with the occupant of the vehicle.

One or more of the following example features may be included. The voice profile may be selected from a voice library. The voice profile may be generated using a voice model. The voice model may be based upon, at least in part, a sampling of audio. The voice model may be based upon, at least in part, a manual selection of a plurality of voice characteristics. Determining the voice profile of the avatar for the scenario of the plurality of scenarios may include determining a responsiveness level of the occupant of the vehicle to the voice profile of the avatar. The responsiveness level of the occupant of the vehicle may be matched to a level of the scenario of the plurality of scenarios.

In another example implementation, a computer program product may reside on a computer readable storage medium having a plurality of instructions stored thereon which, when executed across one or more processors, may cause at least a portion of the one or more processors to perform operations that may include but are not limited to identifying a scenario of a plurality of scenarios associated with an occupant of a vehicle. A voice profile of an avatar may be determined for the scenario of the plurality of scenarios associated with the occupant of the vehicle. The voice profile of the avatar determined for the scenario of the plurality of scenarios associated with the occupant of the vehicle may be selected, wherein the voice profile of the avatar may be selected from a plurality of voice profiles. Audio may be provided to the occupant of the vehicle using the voice profile of the avatar based upon, at least in part, identifying the scenario of the plurality of scenarios associated with the occupant of the vehicle.

One or more of the following example features may be included. The voice profile may be selected from a voice library. The voice profile may be generated using a voice model. The voice model may be based upon, at least in part, a sampling of audio. The voice model may be based upon, at least in part, a manual selection of a plurality of voice characteristics. Determining the voice profile of the avatar for the scenario of the plurality of scenarios may include determining a responsiveness level of the occupant of the vehicle to the voice profile of the avatar. The responsiveness level of the occupant of the vehicle may be matched to a level of the scenario of the plurality of scenarios.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF DRAWINGS

FIG. 1 is an example diagrammatic view of an avatar process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of an avatar process according to one or more example implementations of the disclosure;

FIG. 4 is an example diagrammatic view of a screen image displayed by an avatar process according to one or more example implementations of the disclosure; and

FIG. 5 is an example diagrammatic view of a voice library used by an avatar process according to one or more example implementations of the disclosure.

Like reference symbols in the various drawings may indicate like elements.

### DESCRIPTION

### System Overview:

Generally, vehicles may use voice audio to communicate with the occupant of a vehicle. The selection of the voices utilized by the vehicle is, generally, fairly limited. For example, some vehicles allow you to select language, male/female, and accents. It has been discovered that some occupants may be more responsive to certain voices, especially those they are familiar with, have a strong emotional bond with, or greatly respect. For example, the voice of a family member or friend. Therefore, as will be discussed in greater detail below, the present disclosure may involve creating an avatar, such as a voice and/or visual avatar, that may be used to communicate with a vehicle's occupant in such a way that they may be more responsive to the avatar's communication. In some implementations, the voice avatar may be created by sampling a person's voice and then digitally re-creating that voice to interact with the occupant of the vehicle more naturally. In some implementations, the avatar may be modeled on occupant preferences and with voices of an occupant selected companion.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

Software may include artificial intelligence (AI) systems, which may include machine learning or other computational intelligence. For example, AI may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, and others. Except where context specifically indicates otherwise, references to AI, or to one or more examples of AI, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression based models, decision trees, hidden forests, Hidden Markov models, Bayesian models, and the like. In some implementations, the present disclosure may include combinations where an expert system uses one neural network for classifying an item and a different (or the same) neural network for predicting a state of the item.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), etc. may execute the computer readable program instructions/code by utilizing state information of the computer readable program instructions to personalize the electronic circuitry, in order to perform aspects of the present disclosure. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an AI system-on-chip, a video processing system-on-chip, an organ-on-chip, a quantum algorithm system-on-chip, etc.

Examples of processing hardware may include, e.g., a central processing unit (CPU), a graphics processing unit (GPU), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an AI co-processor.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

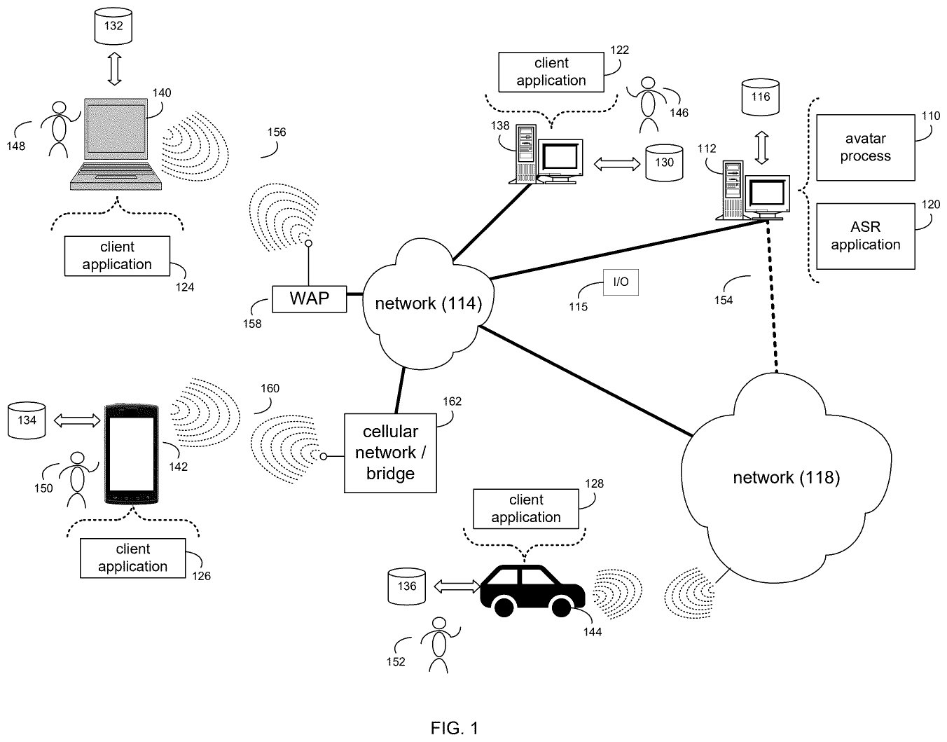

Referring now to the example implementation of FIG. 1, there is shown avatar process 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an avatar process, such as avatar process 110 of FIG. 1, may identify, by a computing device, a scenario of a plurality of scenarios associated with an occupant of a vehicle. A voice profile of an avatar may be determined for the scenario of the plurality of scenarios associated with the occupant of the vehicle. The voice profile of the avatar determined for the scenario of the plurality of scenarios associated with the occupant of the vehicle may be selected, wherein the voice profile of the avatar may be selected from a plurality of voice profiles. Audio may be provided to the occupant of the vehicle using the voice profile of the avatar based upon, at least in part, identifying the scenario of the plurality of scenarios associated with the occupant of the vehicle.

In some implementations, the instruction sets and subroutines of avatar process 110, which may be stored on storage device, such as storage device 116, coupled to computer 112, may be executed by one or more processors and one or more memory architectures included within computer 112. In some implementations, storage device 116 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 116 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, avatar process 110 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute a automatic speech recognition application (e.g., automatic speech recognition application 120), examples of which may include, but are not limited to, e.g., an automatic speech recognition (ASR) application (e.g., modeling, transcription, etc.), a natural language understanding (NLU) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a virtual reality (VR) application, an extended reality (XR) application also known as mixed reality (MR), an augmented reality (AR) application, a web conferencing application, a video conferencing application, a telephony application, a voice-over-IP application, a video-over-IP application, an Instant Messaging (IM)/“chat” application, a chatbot application, an interactive voice response (IVR) application, a short messaging service (SMS)/multimedia messaging service (MMS) application, or other application that allows for ASR type communication. In some implementations, avatar process 110 and/or automatic speech recognition application 120 may be accessed via one or more of client applications 122, 124, 126, 128. In some implementations, avatar process 110 may be a standalone application, or may be an applet/application/script/extension that may interact with and/or be executed within automatic speech recognition application 120, a component of automatic speech recognition application 120, and/or one or more of client applications 122, 124, 126, 128. In some implementations, automatic speech recognition application 120 may be a standalone application, or may be an applet/application/script/extension that may interact with and/or be executed within avatar process 110, a component of avatar process 110, and/or one or more of client applications 122, 124, 126, 128. In some implementations, one or more of client applications 122, 124, 126, 128 may be a standalone application, or may be an applet/application/script/extension that may interact with and/or be executed within and/or be a component of avatar process 110 and/or automatic speech recognition application 120. Examples of client applications 122, 124, 126, 128 may include, but are not limited to, e.g., an automatic speech recognition (ASR) application (e.g., modeling, transcription, etc.), a natural language understanding (NLU) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a virtual reality (VR) application, an extended reality (XR) application also known as mixed reality (MR), an augmented reality (AR) application, a web conferencing application, a video conferencing application, a telephony application, a voice-over-IP application, a video-over-IP application, an Instant Messaging (IM)/“chat” application, a chatbot application, an interactive voice response (IVR) application, a short messaging service (SMS)/multimedia messaging service (MMS) application, or other application that allows for ASR type communication, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, coupled to client electronic devices 138, 140, 142, 144, may be executed by one or more processors and one or more memory architectures incorporated into client electronic devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a laptop computer (e.g., client electronic device 140), a smart/data-enabled, cellular phone (e.g., client electronic device 142), a computer of a vehicle (e.g., client electronic device 144), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smart phones, tablet computers, smart televisions, smart speakers, watches, etc.), an infotainment device (e.g., such as those found in vehicles combining information and/or entertainment with optional screens and/or audio for such things as navigation, multimedia, connectivity, voice control, smartphone integration, touchscreen interface, internet and apps, rear-seat entertainment, etc.), a dedicated network device, and combinations thereof. Client electronic devices 138, 140, 142, 144 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 122, 124, 126, 128 may be configured to effectuate some or all of the functionality of avatar process 110 (and vice versa). Accordingly, in some implementations, avatar process 110 may be a purely server-side application, a purely client-side application, or a hybrid server-side/client-side application that is cooperatively executed by one or more of client applications 122, 124, 126, 128 and/or avatar process 110.

In some implementations, one or more of client applications 122, 124, 126, 128 may be configured to effectuate some or all of the functionality of automatic speech recognition application 120 (and vice versa). Accordingly, in some implementations, automatic speech recognition application 120 may be a purely server-side application, a purely client-side application, or a hybrid server-side/client-side application that is cooperatively executed by one or more of client applications 122, 124, 126, 128 and/or automatic speech recognition application 120. As one or more of client applications 122, 124, 126, 128, avatar process 110, and automatic speech recognition application 120, taken singly or in any combination, may effectuate some or all of the same functionality, any description of effectuating such functionality via one or more of client applications 122, 124, 126, 128, avatar process 110, automatic speech recognition application 120, or combination thereof, and any described interaction(s) between one or more of client applications 122, 124, 126, 128, avatar process 110, automatic speech recognition application 120, or combination thereof to effectuate such functionality, should be taken as an example only and not to limit the scope of the disclosure.

In some implementations, one or more of users 146, 148, 150, 152 may access computer 112 and avatar process 110 (e.g., using one or more of client electronic devices 138, 140, 142, 144) directly through network 114 or through network 118. Further, computer 112 may be connected to network 114 through network 118, as illustrated with phantom link line 154. Avatar process 110 may include one or more user interfaces, such as browsers and textual or graphical user interfaces, through which users 146, 148, 150, 152 may access avatar process 110.

In some implementations, the various client electronic devices may be directly or indirectly coupled to network 114 (or network 118). For example, client electronic device 138 is shown directly coupled to network 114 via a hardwired network connection. Further, client electronic device 144 is shown directly coupled to network 118 via a hardwired network connection. Client electronic device 140 is shown wirelessly coupled to network 114 via wireless communication channel 156 established between client electronic device 140 and wireless access point (i.e., WAP 158), which is shown directly coupled to network 114. WAP 158 may be, for example, an IEEE 802.11a, 802.11b, 802.11g, 802.11n, 802.11ac, Wi-Fi®, RFID, and/or Bluetooth™ (including Bluetooth™ Low Energy) or any device that is capable of establishing wireless communication channel 156 between client electronic device 140 and WAP 158. Client electronic device 142 is shown wirelessly coupled to network 114 via wireless communication channel 160 established between client electronic device 142 and cellular network/bridge 162, which is shown by example directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used. In some implementations, computer 112 may be directed or controlled by an operator. Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third-party offering software as a service (SaaS), platform as a service (PaaS), and/or infrastructure as a service (IaaS). Computer 112 may be implemented using agile development and operations (DevOps) principles. In some implementations, some or all of computer 112 may be implemented in a multiple-environment architecture. For example, the multiple environments may include one or more production environments, one or more integration environments, one or more development environments, etc.

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken information from a user and convert it to usable digital information. An audio codec may likewise generate audible sound for a user, such as through a speaker, e.g., in a handset of a client electronic device. Such sound may include sound from voice telephone calls, may include recorded sound (e.g., voice messages, music files, etc.) and may also include sound generated by applications operating on the client electronic devices.

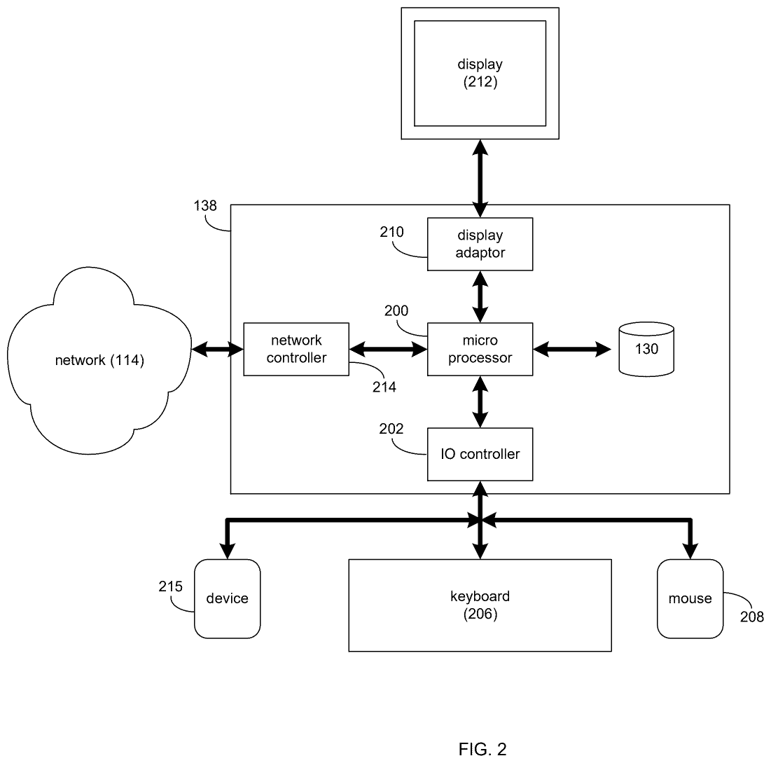

Referring also to the example implementation of FIG. 2, there is shown a diagrammatic view of client electronic device 138. While client electronic device 138 is shown in this figure, this is for example purposes only and is not intended to be a limitation of this disclosure, as other configurations are possible. Additionally, any computing device capable of executing, in whole or in part, avatar process 110 may be substituted for client electronic device 138 (in whole or in part) within FIG. 2, examples of which may include but are not limited to computer 112 and/or one or more of client electronic devices 138, 140, 142, 144.

In some implementations, client electronic device 138 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 130). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), scanner, custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to network 114 (e.g., the Internet or a local area network).

As will be discussed below, avatar process 110 may at least help, e.g., improve ASR and AI based technology, necessarily rooted in computer technology in order to overcome an example and non-limiting problem specifically arising in the realm of computer systems, and being integrated into the example and non-limiting practical application of using the most effective avatar depending on the situation to achieve the best responsiveness of a vehicle's occupant. It will be appreciated that the computer processes described throughout are integrated into one or more practical applications, and when taken at least as a whole are not considered to be well-understood, routine, and conventional functions.

### The Avatar Process:

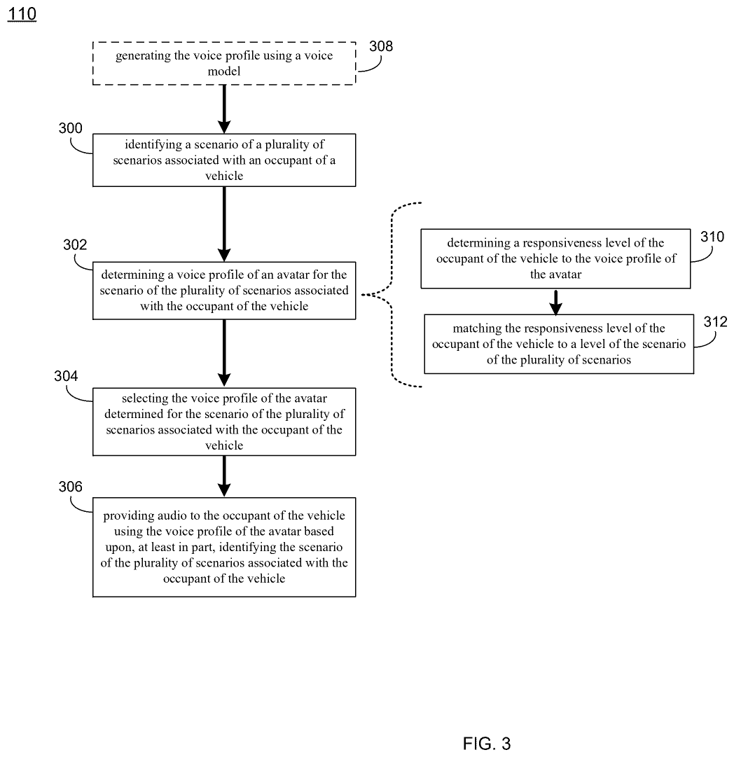

As discussed above and referring also at least to the example implementations of FIGS. 3-5, avatar process 110 may identify 300, by a computing device, a scenario of a plurality of scenarios associated with an occupant of a vehicle (e.g., with client electronic device 144). Avatar process 110 may determine 302 a voice profile of an avatar for the scenario of the plurality of scenarios associated with the occupant of the vehicle. Avatar process 110 may select 304 the voice profile of the avatar determined for the scenario of the plurality of scenarios associated with the occupant of the vehicle, wherein the voice profile of the avatar may be selected from a plurality of voice profiles. Avatar process 110 may provide 306 audio to the occupant of the vehicle using the voice profile of the avatar based upon, at least in part, identifying the scenario of the plurality of scenarios associated with the occupant of the vehicle.

In some implementations, avatar process 110 may generate 308 the voice profile using a voice model. For instance, assume for example purposes only that there are various phases for generating a voice profile using a voice model (e.g., via an AI engine of avatar process 110). The first example phase may be an initialization training, the second phase may be the actual operational execution, and the third may be operational tuning. In some implementations, from a training standpoint, there may be two example main channels to be trained against. One may be the user (or occupant) response. The second may be the voice model itself.

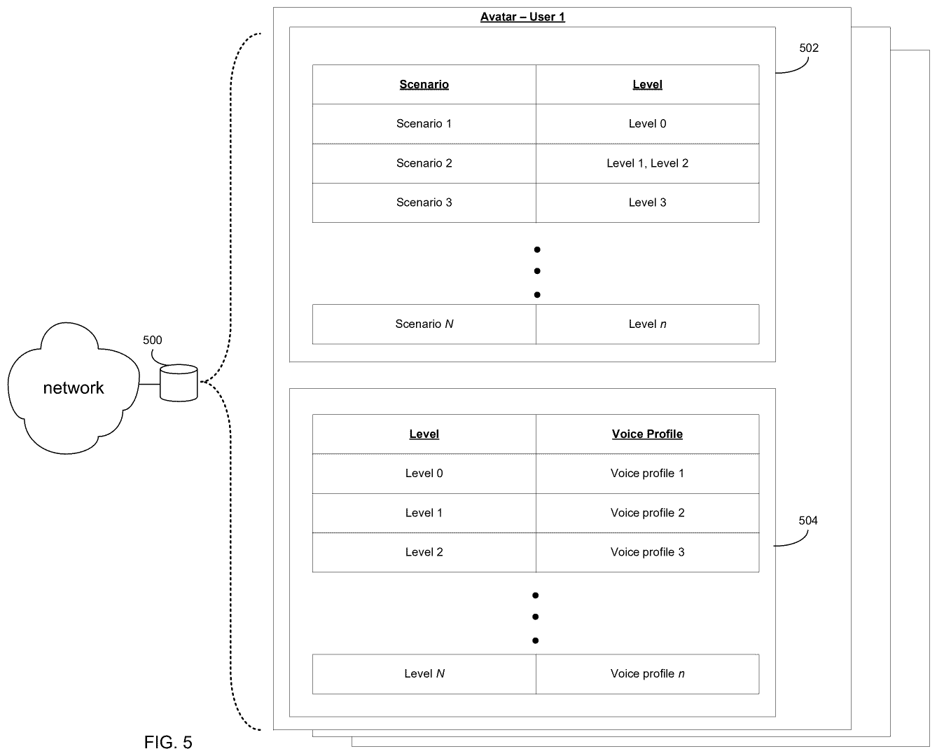

In some implementations, the voice model may be based upon, at least in part, a sampling of audio. For example, starting with the voice model (e.g., as this may be the voice that an avatar (e.g., agent) uses in its communication to the occupant), the occupant or other user may start a microphone recording (e.g., via a client electronic device, such as a smart phone or infotainment system within a vehicle, etc.). In the example, the avatar (e.g., via avatar process 110) may request some phrases to be said aloud, that may ask for different inflections or tones, and avatar process 110 may use this input to recreate a vocal library and a vocal signature for that voice. Once sufficient information has been gathered via the initiation process, avatar process 110 may create and store a vocal signature in its datastore (as shown in the example implementation datastore 500 of FIG. 5 discussed further below), and now the occupant's own voice (or the voice of anyone partaking in the initialization phase) may be used as the avatar's voice in the future. In some implementations, avatar process 110 may be based off a Large Language Model (LLM), although other types of language models may also be used without departing from the scope of the present disclosure. In some implementations, the vocal signature may be unique to each individual voice library, and may train against the unique vocal signatures of each person. Thus, anybody may have their voice sampled such that the voice may be mirrored or recreated and used as the avatar's voice (e.g., via pitch and tone manipulation, voice morphing software, voice synthesis, various text-to-speech models, etc.).

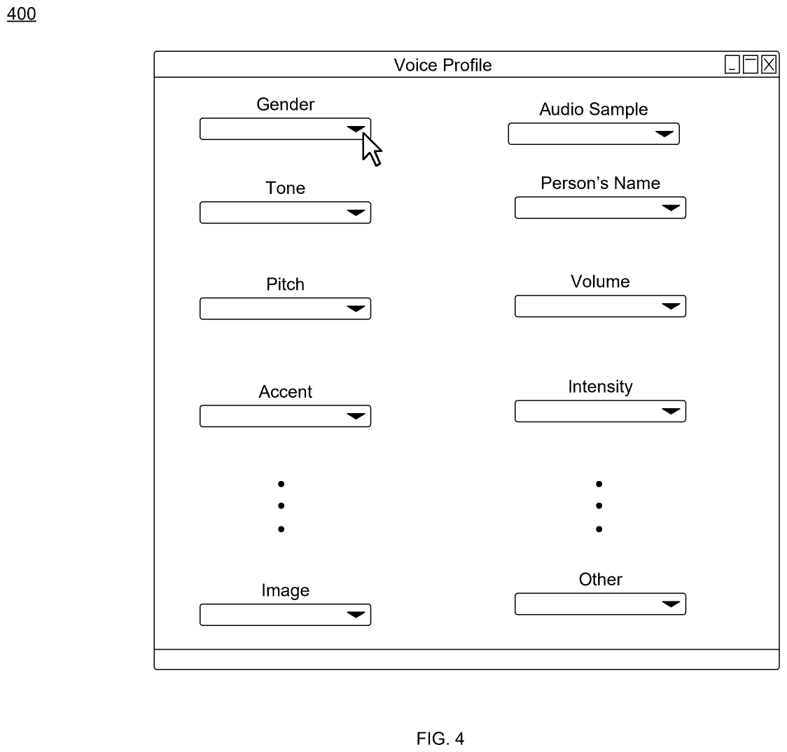

In some implementations, the voice model may be based upon, at least in part, a manual selection of a plurality of voice characteristics. For instance, in some implementations, there may be a list of presets from which the occupant may use to build a custom voice. For example, and referring at least to the example implementation of FIG. 4, an example user interface (UI 400) is shown. In the example, a user may use any input method (e.g., touch screen, voice, mouse, etc.) to select various inputs to manually build their own avatar's voice, which may then be stored in datastore 500. Example and non-limiting options may include, e.g., gender, tone, pitch, accent, a person's name (that may have their voice characteristics available for use as a template), volume, intensity, as well as the ability to upload an audio sample or image for use with to represent the avatar. It will be appreciated after reading the present disclosure that more or less options may be provided in UI 400 without departing from the scope of the present disclosure. As such, the use of these options should be taken as example only and not to otherwise limit the scope of the present disclosure.

The following description involves using the avatar's voice in a vehicle (e.g., navigation, music, calls/texts, warnings, or any other in-car systems); however, it will be appreciated that other uses fall under the scope of the present disclosure. For instance, in some implementations, the avatar's voice may be used for other purposes, such as voice assistants, smart home control, smartphones, accessibility, entertainment, gaming, healthcare, customer service, language translation, security and access control, etc.

In some implementations, initialization of the voice model may include the occupant's (or other end user's) response (e.g., as the driver, passenger, etc.) as avatar process 110 cycles through certain scenarios, such as entertainment scenarios (e.g., involving the infotainment system), or driving scenarios, such as ramping onto a highway, aggressive braking, aggressive turning, lane change/merge warnings, falling asleep alerts, etc., and avatar process 110 may cycle through some prompts just like would be done to inform the (in this example) driver. In some implementations, avatar process 110 may also cycle through different voices, different inflections, tones, pitches, volumes, etc. to identify how the driver responds. For instance, does the driver tend to respond/react faster or slower (or at all) to louder voices, softer voices, voices with strong inflections, voices of themselves, voices of someone more familiar like a family member or famous person? Other considerations may be a preselected preferred method or voice profile that the driver likes to communicate with the avatar, etc. As will be discussed in greater detail below, avatar process 110 may use these data points to determine which voice profiles to use during various scenarios.

In some implementations, avatar process 110 may identify 300, by a computing device, a scenario of a plurality of scenarios associated with an occupant of a vehicle. For instance, assume for example purposes only that avatar process 110 identifies that a particular user(s) (e.g., user 150) is the driver of a vehicle. This may be done using various techniques, such as, e.g., biometrics like facial recognition, voice recognition, proximity detection between a client electronic device (e.g., 142) and the vehicle, etc.

In some implementations, the voice profile(s) may be selected from a voice library. For instance, as mentioned above, and referring again to the example implementation of FIG. 5, the user (e.g., user 150) may have one or more associated avatar profiles stored locally and/or remotely. In some implementations, some or all of these avatar profiles may be downloaded to the vehicle upon detection of user 150, and in some implementations, only the mostly used avatar profiles may be downloaded to the vehicle upon detection of user 150, or may be downloaded/updated during certain intervals regardless of user 150 being detected, etc. In some implementations, the voice library may be majority cloud stored, and then based on the end user's profile, or identification of their response structure, avatar process 110 may download and keep embedded the primary voices/voice profiles that are expected to be used by user 150. Thus, once avatar process 110 completes the assessment and has been trained, avatar process 110 may pull the voice profiles from the cloud (or other remote storage) that are the most likely to be used, which will minimize onboard storage and still have the flexibility in the future to re-download or change (e.g., via a sync function between the vehicle and the cloud).

Continuing with the example, avatar process 110 may use one or more sensors (e.g., sensors of the vehicle and/or client electronic devices such as client electronic device 142) to identify one or more scenarios. Example sensors may include, e.g., accelerometers, GPS sensor, engine sensors (e.g., heat, oil, etc.), tire sensors (e.g., air pressure sensors), and more generally, engine control module sensors, exhaust and emission sensors, transmission sensors, anti-lock braking system sensors, steering and suspension sensors, airbag sensors, parking and proximity sensors, rain and light sensors, fuel level sensors, exterior/interior temperature sensors, cameras and lidar sensors, etc. As noted above, example scenarios may include entertainment scenarios (e.g., involving the infotainment system), or driving scenarios, such as ramping onto a highway, aggressive braking, aggressive turning, lane change/merge warnings, falling asleep alerts, etc. Assume for example purposes only that an oil change sensor is used (e.g., via avatar process 110) to determine an engine maintenance scenario where an oil change is due within 1000 miles.

In some implementations, avatar process 110 may determine 302 a voice profile of an avatar for the scenario of the plurality of scenarios associated with the occupant of the vehicle, and in some implementations, avatar process 110 may select 304 the voice profile of the avatar determined for the scenario of the plurality of scenarios associated with the occupant of the vehicle, wherein the voice profile of the avatar may be selected from a plurality of voice profiles. For instance, in some implementations, determining the voice profile of the avatar for the scenario of the plurality of scenarios may include determining 310 a responsiveness level of the occupant of the vehicle to the voice profile of the avatar. For instance, and continuing with the above example, assume that after the initialization stage that avatar process 110 has determined that user 150 is less responsive to voice profile 1, as it may have a lower volume, less inflection, etc. Further assume that avatar process 110 has determined that user 150 is more responsive to voice profile 2, as it may have a higher volume, more inflection, mimic the voice of a loved one, etc. In some implementations, avatar process 10 may match 312 the responsiveness level of the occupant of the vehicle to a level of the scenario of the plurality of scenarios. For instance, and referring again at least to the example implementation of FIG. 5, there is shown an example library of various information (e.g., for each avatar, various scenarios, various levels, various voice profiles, etc.). In the example, information block 502 may include each scenario, along with the associated level. For example purposes only, assume level 0 is associated with serious scenario requiring high responsiveness (e.g., an upcoming turn, or a collision impact sensor, etc.), whereas level 3 is associated with a less serious scenario requiring less responsiveness (e.g., the need for an oil change). Thus, in the example, information block 504 may be used to determine the appropriate voice profile of the avatar to use in its communication with user 150.

In some implementations, avatar process 110 may provide 306 audio to the occupant of the vehicle using the voice profile of the avatar based upon, at least in part, identifying the scenario of the plurality of scenarios associated with the occupant of the vehicle. For instance, assume for example purposes only that the scenario is the oil change scenario (e.g., scenario 3). As this may be a less urgent matter, scenario 3 may be associated with level 3, which is associated with voice profile 3, because it has been determined that user 150 is less responsive to voice profile 3. Therefore, avatar process 110 may provide the audio (and/or visual) warning to user 150 using voice profile 3. Conversely, assume for example purposes only that the scenario is the collision impact sensor scenario (e.g., scenario 1). As this may be a more urgent matter, scenario 1 may be associated with level 0, which is associated with voice profile 1, because it has been determined that user 150 is the most responsive to voice profile 1. Therefore, avatar process 110 may provide the audio (and/or visual) warning to user 150 using voice profile 1.

It will be appreciated after reading the present disclosure that various other types of associations between scenarios, levels, and voice profiles may be used without departing from the scope of the present disclosure. It will also be appreciated that more or less associations may be used as well. For instance, the scenarios may be directly linked to the voice profiles, rather than the scenarios being linked to their associated responsiveness level, where the responsiveness level is linked to the voice profile. As another example, there may be a library of various voices, having assigned a gradient or a numerical value of the driver's responsiveness to each voice profile against a scenario criteria (e.g., a driver is positively responsive to voice profile number 0, or negatively responsive to voice profile 3), and thus avatar process 110 may classify those based on the individual driver that's driving the vehicle, store that in the datastore, and then execute based on the actual environmental context of what is happening (e.g., during the drive) so that the appropriate voice profile with the appropriate responsiveness level is selected for the associated scenario.

In some implementations, avatar process 110 may continue to train its data in operation. For instance, as the driver continues to utilize the system, avatar process 110 may identify additional points of data and information for use in its voice profile selection. As another example, the driver may move to a different state or to a different environment, or the way that they respond to certain scenarios may evolve and change over the lifetime of vehicle ownership, and as such, the AI model of avatar process 110 may continue to train and learn based on a specific Delta threshold. For instance, whenever it is determined that enough of a delta threshold difference in information associated with responsiveness has been observed, it will trigger a relearning mechanism. In some implementations, an alert may be provided to the end user to request another onboarding training session, essentially stating that the responsiveness of the user is too far off from the expected behaviors/responsiveness. Additionally, various other drivers may be identified, where training may need to be initialized for the first time.

In addition to the avatar being voice-related, the avatar may also be visual. For example, one or more vehicle displays may display an image of the person whose voice was sampled to create the voice-related avatar. Further still, future technology may allow for a three-dimensional projection of the avatar within the vehicle, such as the vehicle's front passenger seat.

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “receiving,” “connected,” “engaged,” “adjacent,” “next to,” “on top of,” “above,” “below,” “abutting,” and “disposed,” used herein is to refer to any type of relationship, direct or indirect, between the components in question, and is to apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
identifying, by a computing device, a scenario of a plurality of scenarios associated with an occupant of a vehicle;
determining a voice profile of an avatar for the scenario of the plurality of scenarios associated with the occupant of the vehicle;
selecting the voice profile of the avatar determined for the scenario of the plurality of scenarios associated with the occupant of the vehicle, wherein the voice profile of the avatar is selected from a plurality of voice profiles; and
providing audio to the occupant of the vehicle using the voice profile of the avatar based upon, at least in part, identifying the scenario of the plurality of scenarios associated with the occupant of the vehicle.

2. The computer-implemented method of claim 1, wherein the voice profile is selected from a voice library.

3. The computer-implemented method of claim 1 further comprising generating the voice profile using a voice model.

4. The computer-implemented method of claim 3, wherein the voice model is based upon, at least in part, a sampling of audio.

5. The computer-implemented method of claim 3, wherein the voice model is based upon, at least in part, a manual selection of a plurality of voice characteristics.

6. The computer-implemented method of claim 1, wherein determining the voice profile of the avatar for the scenario of the plurality of scenarios includes determining a responsiveness level of the occupant of the vehicle to the voice profile of the avatar.

7. The computer-implemented method of claim 6 further comprising matching the responsiveness level of the occupant of the vehicle to a level of the scenario of the plurality of scenarios.

8. A computer program product residing on a computer readable storage medium having a plurality of instructions stored thereon which, when executed across one or more processors, causes at least a portion of the one or more processors to perform operations comprising:
identifying a scenario of a plurality of scenarios associated with an occupant of a vehicle;
determining a voice profile of an avatar for the scenario of the plurality of scenarios associated with the occupant of the vehicle;
selecting the voice profile of the avatar determined for the scenario of the plurality of scenarios associated with the occupant of the vehicle, wherein the voice profile of the avatar is selected from a plurality of voice profiles; and
providing audio to the occupant of the vehicle using the voice profile of the avatar based upon, at least in part, identifying the scenario of the plurality of scenarios associated with the occupant of the vehicle.

9. The computer program product of claim 8, wherein the voice profile is selected from a voice library.

10. The computer program product of claim 8, wherein the operations further comprise generating the voice profile using a voice model.

11. The computer program product of claim 10, wherein the voice model is based upon, at least in part, a sampling of audio.

12. The computer program product of claim 10, wherein the voice model is based upon, at least in part, a manual selection of a plurality of voice characteristics.

13. The computer program product of claim 8, wherein determining the voice profile of the avatar for the scenario of the plurality of scenarios includes determining a responsiveness level of the occupant of the vehicle to the voice profile of the avatar.

14. The computer program product of claim 13, wherein the operations further comprise matching the responsiveness level of the occupant of the vehicle to a level of the scenario of the plurality of scenarios.

15. A computing system including one or more processors and one or more memories configured to perform operations comprising:
identifying a scenario of a plurality of scenarios associated with an occupant of a vehicle;
determining a voice profile of an avatar for the scenario of the plurality of scenarios associated with the occupant of the vehicle;
selecting the voice profile of the avatar determined for the scenario of the plurality of scenarios associated with the occupant of the vehicle, wherein the voice profile of the avatar is selected from a plurality of voice profiles; and
providing audio to the occupant of the vehicle using the voice profile of the avatar based upon, at least in part, identifying the scenario of the plurality of scenarios associated with the occupant of the vehicle.

16. The computing system of claim 15, wherein the voice profile is selected from a voice library.

17. The computing system of claim 15, wherein the operations further comprise generating the voice profile using a voice model.

18. The computing system of claim 17, wherein the voice model is based upon, at least in part, a sampling of audio.

19. The computing system of claim 17, wherein the voice model is based upon, at least in part, a manual selection of a plurality of voice characteristics.

20. The computing system of claim 15, wherein determining the voice profile of the avatar for the scenario of the plurality of scenarios includes:
determining a responsiveness level of the occupant of the vehicle to the voice profile of the avatar; and
matching the responsiveness level of the occupant of the vehicle to a level of the scenario of the plurality of scenarios.
